(19) United States
(12) Patent Application Publication
(10) Pub. No.: US 2003/0213179 A1
(43) Pub. Date: Nov. 20, 2003

(54) Slider window assembly

(76) Inventor: Jim Galer, Hudsonville, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/408,047

(22) Filed: Apr. 4, 2003

Related U.S. Application Data
(60) Provisional application No. 60/372,336, filed on Apr. 12, 2002.

(51) Int. Cl. E06B 3/32

(52) U.S. Cl. 49/413

(57) ABSTRACT

A vehicular slider window assembly includes a fixed pane, with an opening formed at a generally central portion of the fixed pane, and a sliding pane that is adapted for movement over the opening to thereby open and close the opening, The window assembly further includes at least one guide for guiding the sliding pane, which is mounted at the fixed pane.

This application claims priority from provisional Pat. application Ser. No. 60/372,336, which is incorporated by reference in its entirety herein.

### TECHNICAL FIELD AND BACKGROUND OF THE INVENTION

The present invention relates to a window assembly and, more particularly, to a slider window assembly that is particularly suitable for mounting in a rear opening of a vehicle, such as a backlite in a rear opening of a light truck, such as a pick-up truck.

Conventional slider window assemblies for rear openings in trucks or the like typically include three panes—two fixed panes and at least one sliding pane, which is positioned between the two panes. The fixed panes are supported in a spaced relationship by a support, such as a frame. The support integrates the fixed panes as well as rails for supporting the sliding pane into an assembly that can be handled as a unit to facilitate installation.

Optionally, the support for these slider window assemblies can provide a flush mounting of the window assembly in the vehicle opening. In some cases, fasteners are embedded in the support or are otherwise attached to the fixed panes to mount the window in the vehicle. Conventional slider window assemblies are potentially subject to seal leaks or failures. Conventional window assemblies also tend to require significant assembly time at the window assembly plant because of the multitude of components that comprise the window assembly and the precision with which the fixed panes must be located on the frame or supporting structure. Hence, these window assemblies can be more costly to manufacture.

Consequently, there is a need for a simpler slider window assembly that can preferably provide a flush slider window assembly that is preferably easier to manufacture and install and, further, that can provide an improved seal between the window assembly and the vehicle body.

### SUMMARY OF THE INVENTION

Accordingly, the present invention provides a simplified slider window assembly that is easy to install and that can be flush mounted in a vehicle and, further, that can achieve a superior seal over prior known window assemblies.

In one form of the invention, a slider window assembly includes a fixed pane, and a sliding pane, which is movably mounted to the fixed pane and movable to open and close an opening formed in the fixed pane.

In one aspect, the sliding window pane is mounted to the fixed pane by a pair of rails. In a further aspect, the rails may comprise generally horizontal rails and support the sliding pane for generally horizontal movement. For example, the rails may comprise channel-shaped or L-shaped members and, further, include seals for sealingly engaging the sliding pane. Furthermore, the rails may be interconnected by generally vertical members. Optionally and preferably the vertical members and the rails are formed, such as by molding, into an assembly to ease manufacture of the window assembly. The vertical members may also include seals for seal the vertical sides of the sliding pane. Alternately, the seals may be directly mounted on the fixed pane around the opening.

In another form, the rails are generally vertical rails and guide the sliding pane for generally vertical movement between its open and closed positions. Preferably, the rails comprise channel-shaped or L-shaped members and include seals for sealingly engaging the vertical sides of the sliding pane. The upper and lower horizontal sides of the sliding pane are sealingly engaged by seals that are either directly mounted to the fixed pane around the opening or by seals provided in generally horizontal members that interconnect the generally vertical members.

In other aspects, the rails may be adapted to guide the sliding pane to a closed position wherein the sliding pane is substantially flush with the fixed pane. For example, the rails may be tapered to guide the sliding pane for horizontal movement between its open and closed positions. Alternately, the rails may include one or more guiding surfaces that guide the sliding pane to its flush, closed position.

In another aspect, the sliding pane is recessed with respect to the fixed pane—or has a “sub-flush” mounting when moved to its closed position.

In further aspects, the rails are inboard from the perimeter of the fixed pane. Optionally, the rails may comprise plastic, metal rails, or composite rails, or the like, which are bonded or otherwise mounted to the inner surface of the fixed pane preferably in board from the perimeter edge of the fixed pane. Preferably, the inner peripheral surface of the fixed pane includes a frit layer that extends around the periphery of the fixed pane, with the rails located in board of the peripheral edge of the fixed pane but preferably generally within the frit layer region so that the rails are not readily visible from outside of the vehicle when the window assembly is mounted in the vehicle.

In other aspects, the fixed pane includes a perimeter edge that is free of attachment such that the window assembly appears to be a floating window when the window is mounted in a vehicle. Preferably, the inner peripheral surface is also free of attachment to a supporting structure—in other words, the window assembly is a frame-less window assembly so that when the window assembly is mounted is a vehicle it can be mounted using a direct bonding method, such as by an adhesive, including a urethane adhesive or the like, which may be applied to the inner peripheral portion of the fixed pane adjacent the sliding pane supporting structure.

It can be appreciated that the present invention provides an improved window assembly that is simpler to assemble and readily installed in an opening of a vehicle at a vehicle manufacturing plant.

These and other objects, advantages, purposes, and features of the invention will become more apparent from the study of the following description taken in conjunction with the drawings.

### DESCRIPTION OF THE DRAWINGS

FIG. 1 is a front elevation view of a slider window assembly of the present invention;

FIG. 2 is a rear elevation view of the window assembly of FIG. 1;

FIG. 3 is a cross-section view taken along line III-III of FIG. 1;

FIG. 4 is an enlarged view of detail IV-IV of FIG. 3;

FIG. 5 is a similar view to FIG. 2 of another embodiment of the slider window assembly of the present invention;

FIG. 6 is a view similar to FIG. 4 illustrating another embodiment of the window assembly of the present invention;

FIG. 7 is an enlarged elevation view of the sliding pane of FIG. 6;

FIG. 8 is a plan view of the window assembly of FIG. 6;

FIG. 9 is an enlarged view of detail IX-IX of FIG. 8; and

FIG. 10 is a similar view to FIG. 9 illustrating an optional latch mechanism for the sliding pane of FIG. 9.

### DETAILED DESCRIPTION OF THE PREFERRED EMBODIMENT

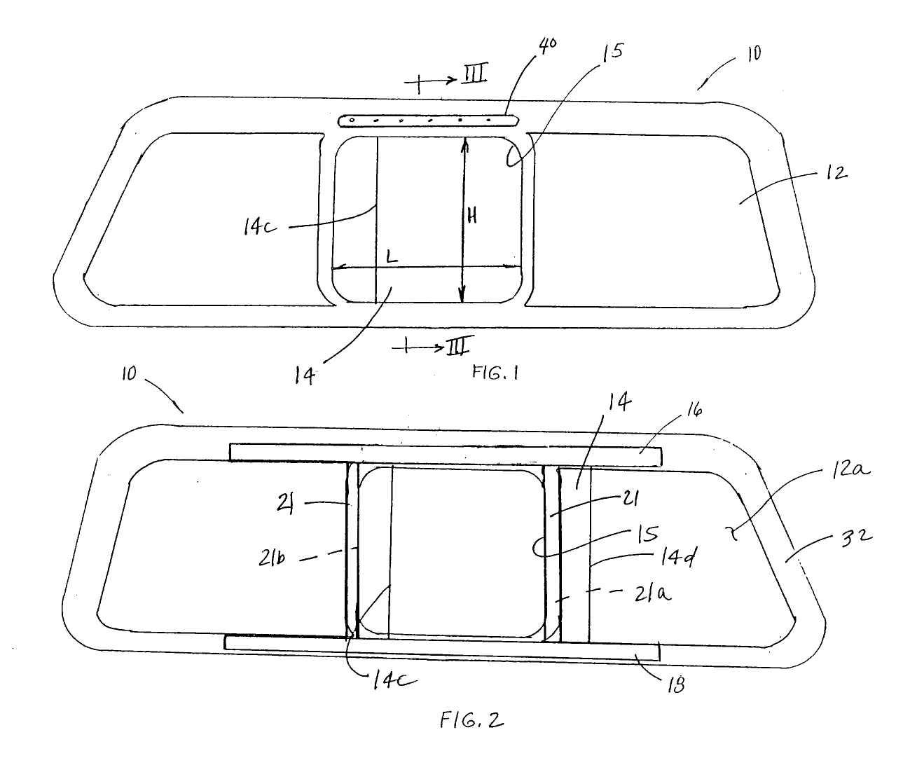

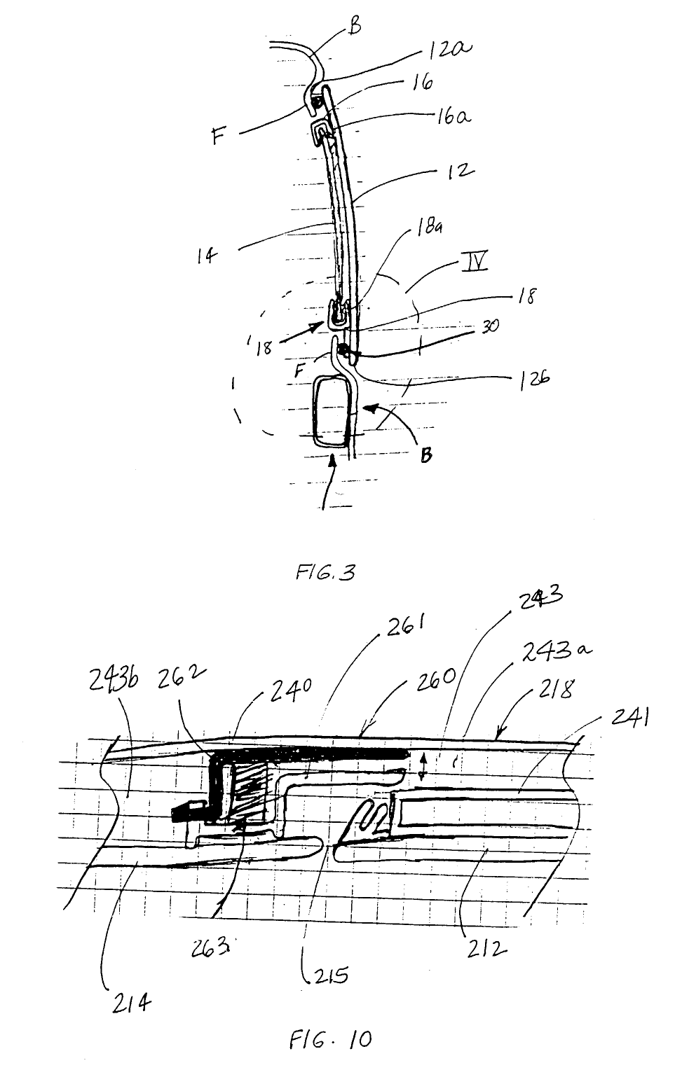

Referring to FIGS. 1 and 2, the numeral 10 generally designates a slider window assembly of the present invention. Slider window assembly 10 is particularly suitable for use as a rear window or backlite of a vehicle, such a light truck, including a pick-up truck or the like. Window assembly 10 incorporates a single fixed pane 12, which includes an opening 15 formed therein that is opened and closed by a sliding pane 14, which is movably mounted to the inner surface of the fixed pane. Opening 15 typically has a length or width L, which extends along the length of the window assembly, of at least nine inches, more preferably twelve inches, and, most preferably, at least eighteen inches. The height H of the opening, which extends along the height of the window assembly in the vertical direction (when mounted to the vehicle) is preferably at least nine inches, more preferably twelve inches, and, most preferably, at least eighteen inches.

In the illustrated embodiment, sliding pane 14 is supported for horizontal movement over opening 15 by a pair of rails 16, 18, which are mounted to the rear surface 12a of fixed pane 12. In this manner, window assembly 10 may be assembled as a window assembly unit that can be manufactured at a window assembly plant that is located remotely from a vehicle assembly plant. Furthermore, since the window assembly is supplied as a unit, it can be handled more easily, especially during installation at the vehicle assembly plant, where the window assembly unit is mounted in an opening or recess in the vehicle body. In addition, window assembly 10 is configured so that it can be mounted in a vehicle body preferably with a generally flush mounting such that at least the fixed pane appears to lie in the same plane as the vehicle body or follow the contour of the vehicle body and, preferably, in a manner so the fixed pane appears to be floating in the vehicle body opening. Furthermore, as will be more fully described below, window assembly 10 may be mounted in the vehicle by direct bonding with the vehicle body.

Panes 12 and 14 preferably comprise transparent glass panes, including tinted transparent glass panes; however, it can be appreciated that panes 12 or 14 may be laminated or may comprise a polymeric pane, including a plastic pane. As will be more fully described below, fixed pane 12 provides sufficient rigidity and support to sliding pane 14 so that assembly 10 may be mounted in an opening of a vehicle as a unit while eliminating the need for a separate or integral support structure, such as a frame or the like, for the window assembly.

Referring to FIG. 2, window assembly 10 includes an upper horizontal rail 16 and a lower horizontal rail 18 mounted to the inner surface of fixed pane 12, which are spaced apart to provide support to the upper and lower edges of sliding pane 12. Rails 16 and 18 provide or have formed therein a longitudinal channel or groove in which sliding pane 14 is moved, which is offset form the plane of fixed pane 12. In this manner, when pane 14 is moved to its closed position over opening 15, pane 14 is offset inwardly from the plane of the fixed pane to form a “sub-flush” mounting arrangement for pane 14. As used above, the term “inwardly” refers to the relative position, for example, of the sliding pane with respect to the fixed pane when the window assembly is mounted in the vehicle. Similarly, references to “inner” and “exterior” are used as nomenclature relative to when the window assembly mounted in the vehicle.

Rails 16 and 18 are mounted to the inner surface 12a of fixed pane 12, for example, by an adhesive, such as a urethane adhesive, including a one part or two part urethane adhesive, an epoxy adhesive, an acrylic adhesive, a polyvinylbutyral adhesive, a silicone adhesive, or the like. Reference is made to U.S. Pat. Nos. 4,364,214; 4,364,595; 6,299,255; and 6,220,650 for examples of suitable adhesives, which are incorporated by reference in their entireties. Referring to FIG. 3, rails 16 and 18 comprise generally U-shaped or channel-shaped members with downwardly and upwardly depending flanges 16a and 18a, respectively, which optionally and preferably include recessed mounting surfaces for receiving the adhesive for adhesively mounting rails 16 and 18 to fixed pane 12. It should be understood that rails 16 and 18 may have other configurations while still achieving the same guiding function for sliding pane 14. Rails 16 and 18 are preferably formed from a rigid material, such as a polymeric material, including glass filled nylon, PVC, or the like. Rails 16 and 18 may also comprise a metal material or may comprise a composite material, such as a filled polymeric or a metal member that is encapsulated in plastic, for example.

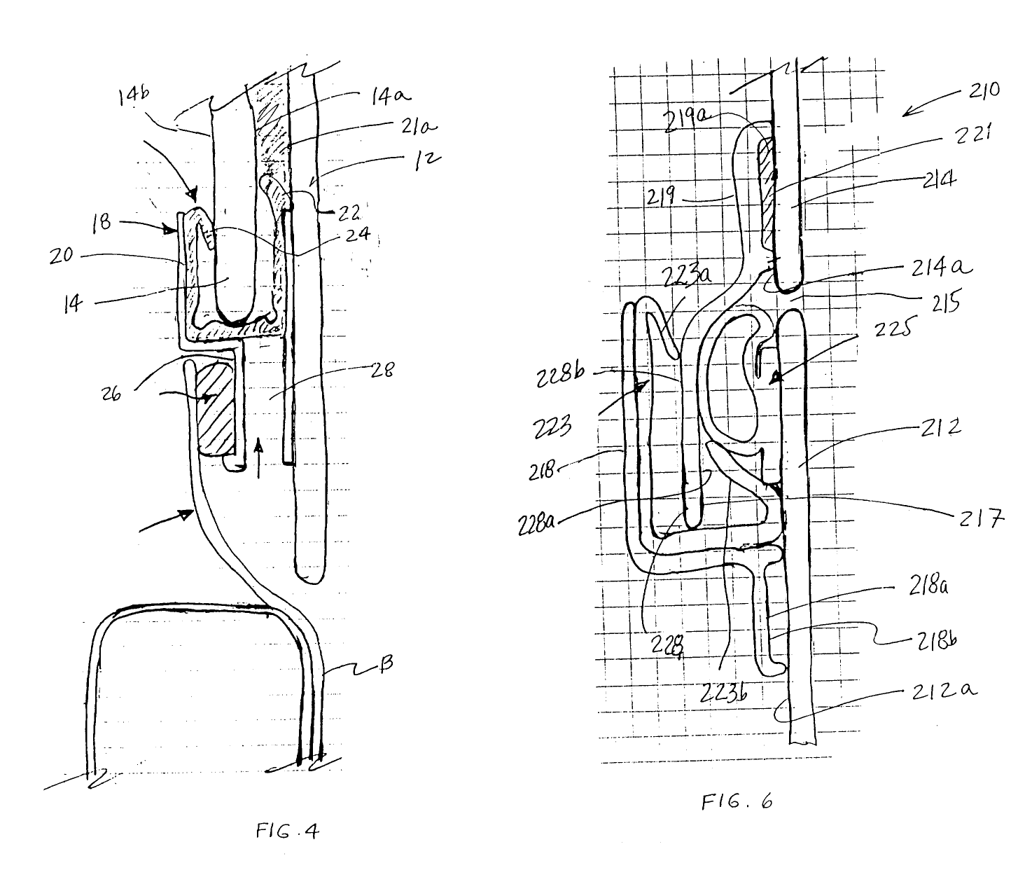

Sliding pane 14 extends into the respective channels or grooves provided by rails 16 and 18 so that pane 14 is supported for generally horizontal movement. Preferably positioned in the respective grooves of rails 16 and 18 are seals 20 (FIG. 4), which sealingly engage sliding pane 14. For ease of description reference will be made herein after to the seal in lower rail 18. It should be understood that the seal in the upper rail preferably has an inverted configuration to that of the seal in the lower rail, but the seals may also have different configurations. In the illustrated embodiment, seal 20 in lower rail 18 comprises a generally U-shaped seal with an upwardly extending leg 22, which sealingly engages the exterior surface 14a of sliding pane 14, and a folded, downwardly depending leg portion 24, which sealingly engages the inner surface 14b of sliding pane 14. Seal 20 may comprise other shaped seals, such as a double-L seal, a V seal, a C -shaped seal, a bulbous seal, or one of a number of different shaped-seals and preferably comprises a polypropylene material (PPE). Examples of suitable seals can be found in U.S. Pat. Nos. 6,220,650; and 6,299,235, which are incorporated by reference herein in their entireties. In addition, seal 20 may be slip-coated or flocked, as is known in the seal art.

Vertical sides 14c and 14d of sliding panes 14 are sealingly engaged by seals 21a and 21b, which are mounted to the inner surface 12a of fixed pane 12 so that when sliding pane 14 is moved to its closed position, the full periphery of sliding pane 14 will be sealed by seals 20, 21a, and 21b. Seals 21 and 2b may comprise Y-shaped seals or the various other shaped seals noted above. Optionally, lower rail 18 includes one or more downwardly depending tubular members 26, which form drainage pathways or channels 28 for water that may collect in rail 18.

Alternately, seals 21a and 21b may be supported in generally vertical members 21, such as channel-shaped or L-shaped members, which interconnect upper and lower rails 16 and 18 to form a generally H-shaped sliding pane support assembly. Vertical members 21 may be formed from a plastic material, a metal material, or a composite material, similar to rails 16 and 18. In addition, vertical members 21 and rails 16 and 18 may be formed, such as by molding, as a single support assembly. Reference is made to copending application Ser. No. 10/113,056, filed Apr. 1, 2002, entitled HORIZONTAL SLIDER WINDOW ASSEMBLY, by David E. Nestell, Darin J. Snider, Loren B. Renkema, and Jim Galer (Attorney Docket No. DON02 P-965), which is incorporated by reference in its entirety. In this manner, rails 16 and 18 and vertical members 21 form a support assembly that can be mounted to fixed pane 12 as a unit. Optionally and preferably, seals 21a, 21b, and 20 comprise a unitary H-shaped seal, such as disclosed in U.S. pat. Ser. No. 09/638,433, filed Aug. 14, 2000, entitled POWER SLIDER WINDOW ASSEMBLY (Attorney Docket No. DON02 P-823) which is herein incorporated by reference in its entirety. Alternately, as described in the reference pending application, the seal or seals may be injection molded, for example from SANTOPRENE® brand polymeric material available from Monsanto Corporation. However, the seal(s) may be formed from other materials, including EPDM and thermoplastic elastomers. Furthermore, seals 20, 21a, and 21b may be molded with the individual support members or the support assembly, such as by co-injection or the like.

As previously noted, window assembly 10 is directly bonded to the body B of the vehicle by an adhesive, such as a urethane adhesive, including one part or two part urethane adhesive, an epoxy adhesive, an acrylic adhesive, a silicone adhesive, a polyvinylbutyral adhesive, or the like. As best seen in FIG. 3, a bead of adhesive 30 is applied to the inner peripheral surface of fixed pane 12 inward of outer peripheral edge 12b of fixed pane 12 and mounts fixed pane 12 to flange F of vehicle body B. Adhesive bead 30 extends around the full circumference of fixed pane 12 and directly contacts the inner surface 12a of fixed pane 12 except where bead 30 wraps over downwardly depending tubes 26 of lower rail 18 to thereby provide water passageways or channels from lower rail horizontal rail 18. In this manner, window assembly 10 provides a substantially continuous seal plane. In addition, rails 16 and 18 are mounted to fixed pane 12 substantially inward of bead 30. Optionally and preferably, adhesive bead 30 is spaced inwardly from the outer peripheral edge 12b of fixed pane 12, so that as noted above fixed pane 12 appears to be floating in the opening of the vehicle body.

Referring again to FIG. 2, preferably, at least fixed pane 12 includes a frit layer 32 (FIG. 2), which extends around the outer peripheral portion of fixed pane 12 on inner surface 12a. Optionally and preferably, frit layer 32 also extends around opening 15 to thereby conceal the location of seals 21a and 21b and also optional vertical members 21. Frit layer 32 is substantially opaque and functions to facilitate adhering or bonding of fixed pane 12 to vehicle body B, while also improving the appearance of the window by providing a black-out function so that the bonding surfaces are then not visible from the exterior of the window. As a result, frit layer 32 defines a viewing area through the fixed pane.

Referring again to FIG. 1, window assembly 10 may include a center high mounted stop light (CHMSL) 40 mounted to the inner surface of fixed pane 12 above sliding pane 14. CHMSL 40 may comprise a plurality of light emitting diodes (LEDs) or other light sources and is preferably attached to the inner surface of fixed pane 12 by an adhesive, such as the adhesives noted above.

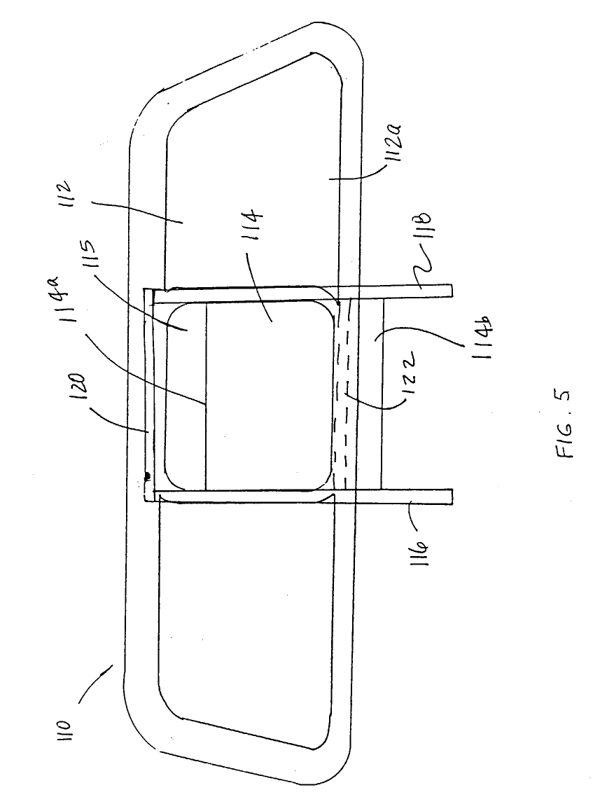

Referring to FIG. 5, the numeral 110 generally designates another embodiment of the slider window assembly of the present invention. Window assembly 110 includes a single fixed pane 112, similar to fixed pane 12, and a sliding pane 114, which is mounted for vertical movement to open and close opening 115, which is formed in fixed pane 112. In the illustrated embodiment, sliding pane 114 is supported for vertical movement by a pair of rails 116 and 118, which are respectively mounted to inner surface 112a of fixed pane 112 by, for example an adhesive, similar to the previous embodiment. Rails 116 and 118 similarly may comprise channel-shaped or L-shaped members and include and support seals for sealingly engaging the vertical edges of sliding pane 114. Seals for sealing the upper and lower horizontal portions of pane 114 may be mounted directly to fixed pane 112 to thereby provide a full circumference seal around sliding pane 114 when sliding pane 114 is in its closed position. For examples of suitable seal shapes and material reference is made to the previous embodiment.

Alternately, rails 116 and 118 may be interconnected by one or more horizontal members 120 and 122, which provide support to rails 116 and 118 and, further, hold and/or support the seals for sealing the upper and lower portions of pane 114. Horizontal members 120 and 122 may comprise channel-shaped or L-shaped members or the like. In this manner, rails 116 and 118 together with horizontal members 120 and 122 form an A-shaped support system. Optionally, the A-shaped support system may be formed, such as by molding, to form a support system assembly that can be mounted to fixed pane 112 as a unit to thereby ease manufacture. Reference is made to copending application Ser. No. 10/113,963, filed Mar. 29, 2002, entitled VERTICAL SLIDER WINDOW ASSEMBLY (Attorney Docket No. DON02 P-966), which is incorporated by reference in its entirety, for an example of a molded A-frame support system.

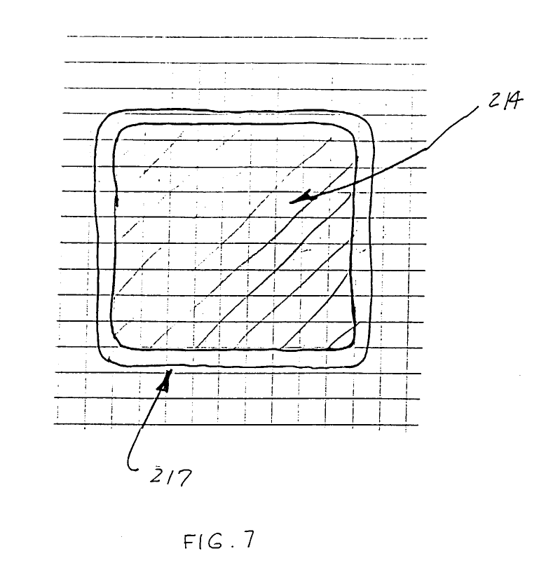

Referring to FIGS. 6 and 7, window assembly 210 of the present invention may incorporate a sliding pane 214, which is substantially flush with fixed pane 212 when moved to its closed position. As best seen in FIG. 7, sliding pane 214 includes a frame 217, such as a plastic frame, which preferably extends around the full periphery of pane 214. Referring again to FIG. 6, plastic frame 217 includes a base 219, which is mounted to inner surface 214a of sliding pane 214 by, for example, an adhesive 221, such as a urethane adhesive, including a one or two-part urethane adhesive, an epoxy adhesive, a silicone adhesive, a polyvinylbutyral adhesive, and an acrylic adhesive or the like. Preferably, base 219 includes a recessed mounting surface 219a for receiving adhesive 221.

Frame 217 further includes a downwardly depending flange 228, which extends outwardly from base 219 and, further, which is offset rearwardly from the plane defined by sliding pane 214. Similar to sliding pane 14, sliding pane 214 is mounted to fixed pane 212 for horizontal movement by upper and lower rails 218 (only the lower rail is illustrated). The upper rail preferably has an inverted configuration of the lower rail; however, it should be understood that the upper rail and the lower rail may have different configurations. In the illustrated embodiment, rail 218 comprises a generally L-shaped member with a downwardly depending flange 218a, which mounts rail 218 to inner surface 212a of fixed pane 212. Optionally and preferably, flange 218a includes a recessed mounting surface 218b for receiving an adhesive (such as previously described) or the like to mount rail 218 to the inner surface 212a of fixed pane 212.

Sliding pane 214 is guided along rail 218s by flange 228, which extends into the channels or grooves formed between rails 218 and the inner surface 112a of fixed pane 112. Positioned in rails 218 are seals 223. For ease of description reference will be made herein after to the seal in lower rail 218. It should be understood that the seal in the upper rail preferably has an inverted configuration to that of the seal in the lower rail, but the seals may also have different configurations. In the illustrated embodiment, seal 223 in lower rail 218 comprises a generally L-shaped seal, which includes a folded, downwardly depending flange 223a for sealingly engaging the inner surface 228b of flange 228 and an upwardly extending flange 223b that cooperates with a seal 225, such as a bulb seal, to seal outer surface 228a of flange 228. Seal 225 is post-attached, for example, by an adhesive, to the inner surface 212a of fixed pane 212 around opening 215. In this manner, when sliding pane 214 is moved from its open position behind fixed pane 212 to its closed position in which sliding pane 214 is positioned in opening 215 and substantially flush with pane 212, seal 225 will compress and deform while still maintaining a seal on outer surface 228a of flange 228. By the same token, when sliding pane 214 is moved from its closed position to its open position behind fixed pane 212, seal 225 will extend to maintain its seal with flange 228.

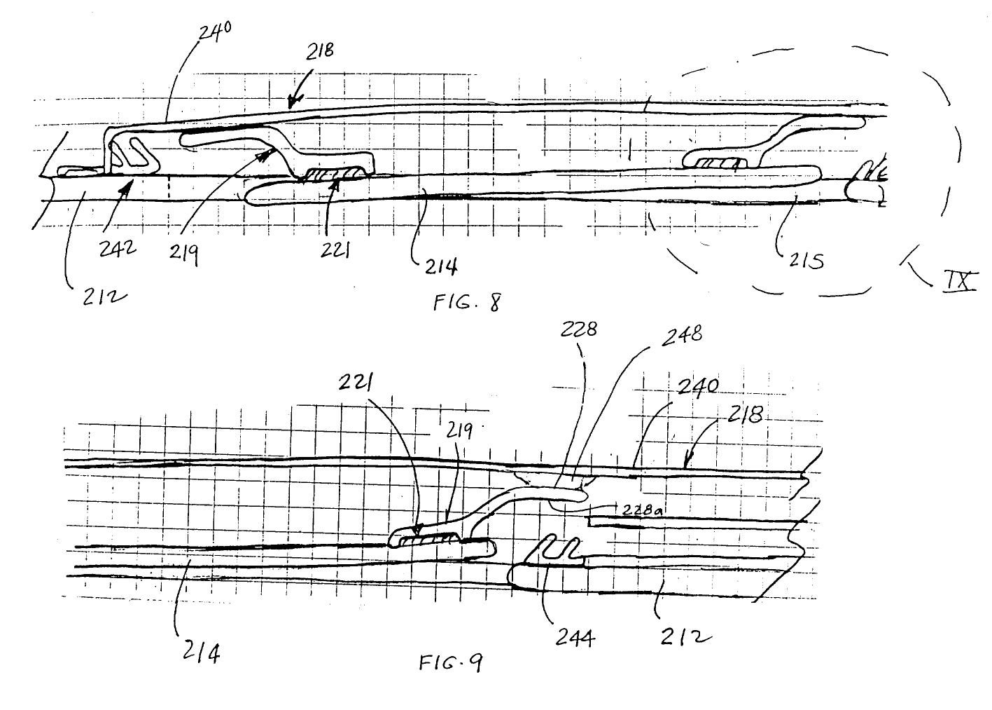

Referring to FIGS. 8 and 9, sliding pane 214 may be guided into its closed position by the shape of rails 218. For example, rails 218 may be tapered along their longitudinal length with flange 240 moving closer to fixed pane 212 over the length of the rail so that when sliding pane 214 is moved generally horizontally in rail 218, flange portion 240 of rail will guide frame 219 to move sliding pane 214 forward relative to fixed pane 212 to move pane 214 into opening 215 between the peripheral edges of fixed pane 212, which define opening 215. In this manner, rails 218 include at least one guide surface to guide sliding pane 214 to its flush, closed position.

Optionally and preferably, rails 218 includes a pair of second seals 242 positioned therein, such as double L-shaped seals, which seal against flange 228 of frame 219 and, further, provides a positioning mechanism to align sliding pane 214 in opening 215. Seals 242 may be post-attached to inner surface of fixed pane 212 by an adhesive similar to seal 225. Another pair of seals 244 is positioned in rail 218 to seal the opposite side of frame 219 when pane 214 is moved to its closed position. Seals 244 may similarly comprise double L-shaped seals, which engage the outer surface 228a of flange 228 of frame 219. Optionally and preferably, rail 218 includes at least one biasing member 248, which urges the trailing side of sliding pane 214 forward to at least generally align with fixed pane 212 when sliding pane 214 is aligned with opening 215. For example, biasing member 248 may comprise a compressible member which includes tapered sides to permit the leading side of sliding pane 214 to move past biasing member 248 when moved to its closed position. It should be understood that rail 218 may include a plurality of spaced biasing members 248 to apply a generally uniform force to frame 219 along the full length of frame 219.

Referring to FIG. 10, the numeral 260 generally designates a latch mechanism, which may be incorporated into window assembly 210. Latch mechanism 260 is mounted to sliding pane 214 and is actuated when sliding pane 214 is generally aligned with opening 215. In the illustrated embodiment, rail 218 includes an upwardly extending flange 240 and a channel member 241, which is mounted to inner surface of fixed pane 212 and positioned between flange 240 and pane 212 to define a narrowed guide path 243a in channel 243, which is defined between flange 240 and pane 212. In this manner, channel member 241 and flange 240 provide guide surfaces for sliding pane 214. Channel member 241 defines a generally linear path 243a for sliding pane 214, which is offset from fixed pane 212 and, further, provides a transition between the narrowed channel or path 243a and the enlarged portion 243b of channel 243.

Latching mechanism 260 includes a base 261 and a pivot member 262, which is pivotally mounted to base 261 to move between a compressed position when sliding pane 214 is in passageway 243a and an extended position when sliding pane 214 is moved to enlarged portion 243b of channel 243. When pivot member 262 is extended, pivot member 262 presses against flange 240 to urge sliding pane 214 toward fixed pane 212 (forwardly) to generally align pane 214 between the inner edges of fixed pane 212 that define opening 215. Pivot member 262 is pivoted between its compressed and extended position by a spring 263, which is positioned between base 261 and pivot member 262 to thereby bias pivot member 262 in its extended position. In this manner, when sliding pane 214 moves past channel-shaped member 241, pivot member 262 is urged by spring 263 to pivot about base 261 to move to its extended position thus urging sliding pane 214 forward when pivot member 262 moves along flange 240 to provide a substantially flush mounting arrangement of sliding pane 214 in opening 215.

It should be understood that other latch mechanisms may be used. For example, a manually operated sliding latch mechanism may be mounted to the sliding pane, which extends into a receiving structure mounted to the fixed pane.

It can be appreciated from the foregoing, that the window assemblies of the present invention eliminate the need to locate fixed panes with respect to a frame or any other supporting structures or elements. In addition, the window assemblies of the present invention include fewer parts than conventional slider window assemblies and do not require studs or a gasket to be molded or otherwise adhered to the window assembly for mounting the window assembly in the vehicle body. As a result, the window assemblies of the present invention are simpler and easier to manufacture. Moreover, the window assemblies of the present invention allow for direct bonding of the fixed pane to the vehicle body and, further, may be mounted in a vehicle body that has an opening configured to receive all three types of window openings, namely fixed windows, horizontal slider windows, and vertical slider windows. Thus, providing greater flexibility to vehicle manufacturers.

While several forms of the invention have been shown and described, other forms will now be apparent to those skilled in the art. For example, while openings 15, 115, and 215 are preferable centrally located, the openings may be offset both along the horizontal axis of the window assembly and along the vertical axis of window assembly. In addition, although the seals are described as separate seals, which are typically push fit into the rails or support members, it is further envisioned as noted that one or more seals may be combined as a single seal and/or integrally molded with the rails and/or the other sliding pane support members. In addition, window assemblies 10, 110, and 210 may incorporate post-attached structures, such as described in U.S. Pat. Nos. 5,352,010 and 5,451,090, which are incorporated by reference in their entireties, and accessories, such as storage compartments or the like mounted thereto, such as disclosed in U.S. Pat. No. 6,231,111, which is incorporated by reference herein in its entirety. For example, window assemblies 10, 110, and 210 may incorporate lights, such as interior map lights or the like, or lights that direct exteriorly of the vehicle, such as brake lights (CHMSL), turn signals, or the like, which may be directly bonded to the fixed pane, such as by an epoxy adhesive, a silicone adhesive, a urethane adhesive, including a one-part and more preferable a two-part urethane adhesive, an acrylic adhesive, and a polyvinylbutyral adhesive, or the like. Therefore, it will be understood that the embodiments shown in the drawings and described above are merely for illustrative purposes, and are not intended to limit the scope of the invention which is defined by the claims which follow as interpreted under the principles of patent law including the doctrine of equivalents.

The embodiments of the invention in which an exclusive property right or privilege is claimed are defined as follows:

1. A vehicular slider window assembly comprising:
a fixed pane including an opening formed at a generally central portion of said fixed pane;
a sliding pane, said sliding adapted for movement over said opening to thereby open and close said opening; and
at least one guide for guiding said sliding pane, said guide being mounted at said fixed pane.

2. The vehicular slider window assembly according to claim 1, wherein said opening has vertical and horizontal dimensions, said sliding pane has at least one dimension greater than at least one of said vertical or horizontal dimensions of said opening.

3. The vehicular slider window assembly according to claim 1, wherein said sliding pane is substantially flush with said fixed pane when said sliding pane closes said opening.

4. The vehicular slider window assembly according to claim 1, wherein said guide comprises a pair of rails.

5. The vehicular slider window assembly according to claim 4, wherein said pair of rails comprises a pair of rails positioned adjacent opposed sides of said opening for guiding said sliding pane.

6. The vehicular slider window assembly according to claim 5, wherein said pair of rails comprises vertical rails for guiding said sliding pane in a vertical direction wherein said sliding pane comprises a vertical sliding pane.

7. The vehicular slider window assembly according to claim 5, wherein said pair of rails are interconnected by at least one rail.

8. The vehicular slider window assembly according to claim 7, wherein said pair of rails are interconnected by at least one horizontal rail.

9. The vehicular slider window assembly according to claim 7, wherein said pair of rails are interconnected by an upper horizontal rail and a lower horizontal rail.

10. The vehicular slider window assembly according to claim 9, wherein said at least one of said upper horizontal rail and said lower horizontal rail includes a seal for sealing against said sliding pane.

11. The vehicular slider window assembly according to claim 9, wherein each of said upper horizontal rail and said lower horizontal rail includes a seal for sealing against said sliding pane.

12. The vehicular slider window assembly according to claim 13, wherein each of said rails of said pair of rails includes a seal for sealing against said sliding pane wherein said sliding pane forms a substantially full circumference seal with said fixed pane when closing said opening.

13. The vehicular slider window assembly according to claim 8, wherein said vertical sliding pane extends into said horizontal rail when closing said opening.

14. The vehicular slider window assembly according to claim 4, wherein said pair of rails comprise channel-shaped rails.

15. The vehicular slider window assembly according to claim 4, wherein said pair of rails comprise L-shaped rails.

16. The vehicular slider window assembly according to claim 1, further comprising seals mounted to said fixed pane for sealing with said sliding pane.

17. The vehicular slider window assembly according to claim 6, wherein said pair of rails comprises a pair of horizontal rails positioned adjacent opposed sides of said opening for guiding said sliding pane in a horizontal direction wherein said sliding pane comprises a horizontal sliding pane.

18. The vehicular slider window assembly according to claim 17, further comprising a pair of seals mounted to said fixed pane adjacent opposed vertical sides of said opening for sealing with said sliding pane.

19. The vehicular slider window assembly according to claim 17, wherein each rail of said pair of rails includes a groove formed therein for receiving the sliding pane therein.

20. The vehicular slider window assembly according to claim 19, wherein said groove is offset from said fixed pane wherein said sliding pane comprises a sub-flush sliding pane.

21. The vehicular slider window assembly according to claim 4, wherein said rails are mounted to said fixed pane by an adhesive.

22. The vehicular slider window assembly according to claim 4, wherein said rails comprise rigid rails.

23. The vehicular slider window assembly according to claim 22, wherein said rails comprise metal rails.

24. The vehicular slider window assembly according to claim 4, wherein said rails comprise polymeric rails.

25. The vehicular slider window assembly according to claim 1, wherein said fixed pane has an outer peripheral edge, further comprising a bead of adhesive applied to said fixed pane inwardly of said outer peripheral edge for securing said window assembly to a vehicle body wherein said window assembly appears to be floating in the vehicle body.

26. The vehicular slider window assembly according to claim 25, wherein said window assembly comprises a flush window assembly and appears to be floating in the vehicle body.

27. The vehicular slider window assembly according to claim 1, wherein said sliding pane comprises a manually movable sliding pane.

28. The vehicular slider window assembly according to claim 1, wherein said sliding pane comprises a power driven sliding pane.

29. A vehicular slider window assembly comprising:
a fixed pane including an outer peripheral edge, said fixed pane having an opening formed therein inward of said outer peripheral edge;
a sliding pane, said sliding adapted for movement over said opening to thereby open and close said opening; and
a support guiding said sliding pane between open and closed positions over said opening, said support mounted to said fixed pane.

30. The vehicular slider window assembly according to claim 29, wherein said support comprises at least a pair of rails.

31. The vehicular slider window assembly according to claim 29, wherein said a pair of rails is mounted to said fixed pane adjacent opposed sides of said opening.

32. The vehicular slider window assembly according to claim 30, wherein said rails are interconnected by a second pair of rails.

33. The vehicular slider window assembly according to claim 32, wherein said second pair of rails is mounted to said fixed pane.

34. The vehicular slider window assembly according to claim 32, wherein said rails are molded as a single support assembly.

35. The vehicular slider window assembly according to claim 31, wherein said pair of rails comprise vertical rails.

36. The vehicular slider window assembly according to claim 31, wherein said rails comprise horizontal rails.

37. The vehicular slider window assembly according to claim 30, wherein said sliding pane is substantially flush with said fixed pane when said sliding pane closes said opening.

38. The vehicular slider window assembly according to claim 37, wherein said pair of rails comprises a pair of tapered rails to guide said sliding pane into said opening.

39. The vehicular slider window assembly according to claim 30, wherein said rails include seals for sealing with said sliding pane.

40. The vehicular slider window assembly according to claim 29, further comprising a bead of adhesive applied to said fixed pane inwardly of said outer peripheral edge for securing said window assembly to a vehicle body.

41. The vehicular slider window assembly according to claim 40, wherein said window assembly appears to be floating in the vehicle body.

42. The vehicular slider window assembly according to claim 29, wherein said sliding pane comprises a manually movable sliding pane.

43. The vehicular slider window assembly according to claim 29, wherein said sliding pane comprises a power driven sliding pane.

44. The vehicular slider window assembly according to claim 29, wherein said support is mounted inward of said inner peripheral portion wherein said window assembly may be flush mounted in a vehicle.
